(19) United States
(12) Patent Application Publication
(10) Pub. No.: US 2001/0035644 A1
(43) Pub. Date: Nov. 1, 2001

(54) Device to emit a scent, associated to a book page or the like

(76) Inventor: Paola Amadeo, Rome (IT)

Correspondence Address: FOGG SLIFER & POLGLAZE, P.A., P.O. BOX 581009, MINNEAPOLIS, MN, 55458-1009, US

(21) Appl. No.: 09/826,659

(22) Filed: Apr. 5, 2001

(30) Foreign Application Priority Data
Apr. 6, 2000 (IT) RM2000A000171

(51) Int. Cl. B42D 3/00

(52) U.S. Cl. 281/31; 281/29; 281/15.1; 283/64

(57) ABSTRACT

A device to emit a scent, associated to a book page or the like, in an easy manner and to a practically indefinite number of readers, comprises: a pad member, bearing a scent to be emitted, of laminar type connected to a surface of said page; a cover panel, applied to said page, delimiting a pocket) which entirely houses said pad member, said cover panel comprising a plurality of easy-tearing lines delimiting a plurality of removable areas, at respective portions of the pad member; and means to seal said pad member inside said pocket.

### DESCRIPTION

The present invention relates to a device to emit a scent, associated to a book page or the like. It further relates to a book, or other type of page-structured support, incorporating one or more of said devices.

As it is known, olfaction is one of the most sensitive senses, which is capable of providing sensations directly at cerebral level via the dedicated nerve fibres, activating, as it has been demonstrated, the neurovegetative functions and the emotional reactions.

Therefore, the scent may provide sensations at a subconscious level, at times even causing spontaneous emotions and inducing recollections.

Hence, the reading-scent combination may give rise to recollections and emotions due to both said factors, further predisposing to a more effective text memorisation by a reader exposed to perfumes and scents relating, for some reason, to the written content.

The selection criteria for the text-scent pairings may differ, also in view of the emotional reaction to be induced in the reader.

The motivations may, e.g., be of emotional, descriptive, didactic nature, etc. In particular, to the description of an emotion a scent, recognised in studies as associable to a specific emotion, may be associated. Still, to the description of an object, e.g., a plant or a flower, just the scent thereof may be associated. Furthermore, for explanatory purposes, not only the scent of an object may be associated to the written word, but also the image thereof.

Other viable associations are possible in the cooking field, associating scents to ingredients of a recipe, as well as in the aromatherapic field.

Several devices for associating a scent to a written text inserted in a book-structured support, of the type commonly used to divulge perfume samples, often for promotional purposes, are known.

Such devices are structured so as to provide a onetime scent emission, with a system of the disposable type.

An example of this type of devices is taught in U.S. Pat. No. 5,188,236.

The technical problem underlying the present invention is that of providing an emitting device allowing to overcome the drawbacks mentioned with reference to the known art.

This problem is solved by a device to emit a scent, associated to a book page or the like, comprising:

a pad member, bearing a scent to be emitted, of laminar type connected to a surface of said page;

a cover panel, applied to said page, delimiting a pocket which entirely houses said pad member, said cover panel comprising a plurality of easy-tearing lines delimiting a plurality of removable areas, at respective portions of the pad member; and

sealing means said pad inside said pocket.

The main advantage of the device to emit a scent according to the present invention lies in allowing to more readers of the same book to associate to the reading and to the figure viewing also the sensations provided by a scent, in an easy and simple to implement manner.

The present invention will hereinafter be described according to a preferred embodiment thereof, given by way of example and not for limitative purposes with reference to the annexed drawings, wherein:

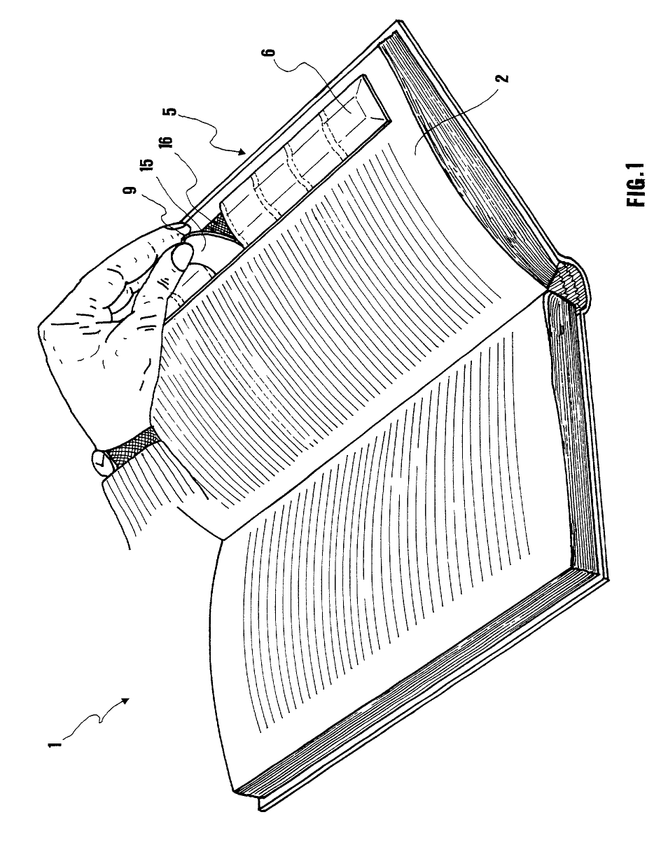

FIG. 1 is a perspective view of a book structure incorporating a device to emit a scent according to the present invention;

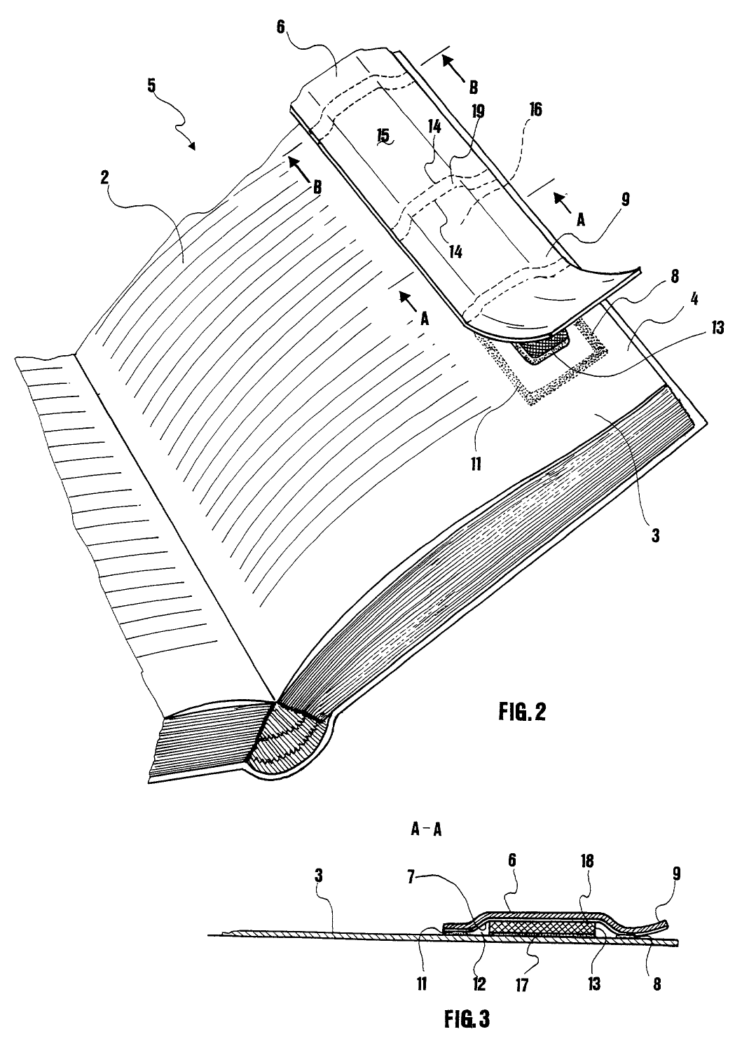

FIG. 2 is an enlarged perspective view of a detail of the structure and of the device of FIG. 1;

FIG. 3 is a cross section view of the device, taken along line A-A of FIG. 2;

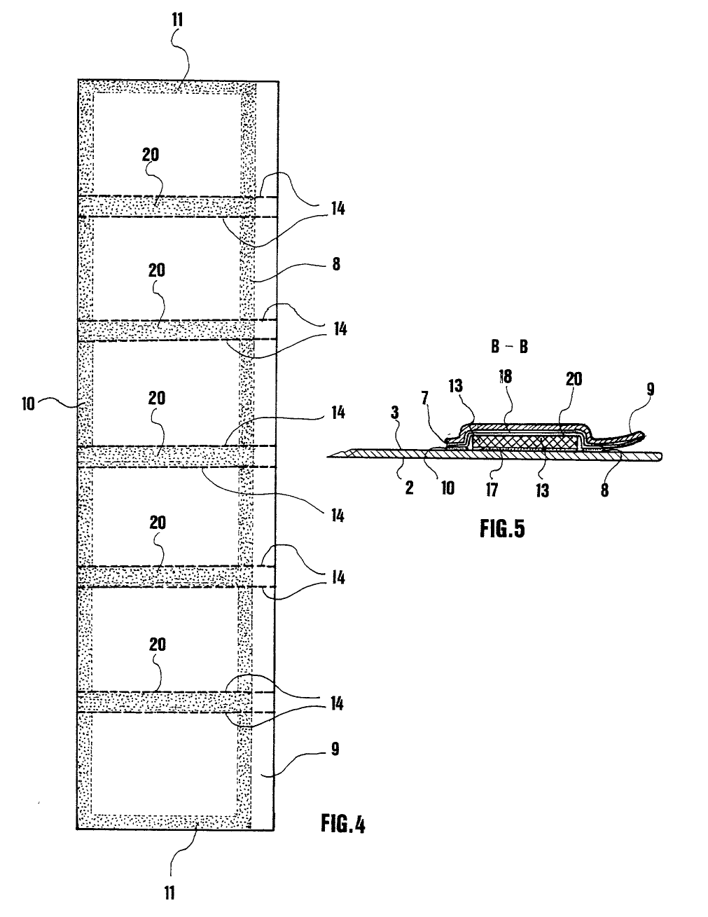

FIG. 4 is a plan view of a construction detail of the device of the preceding FIGS.;

FIG. 5 is a cross section of the device, taken along line B-B of FIG. 2; and

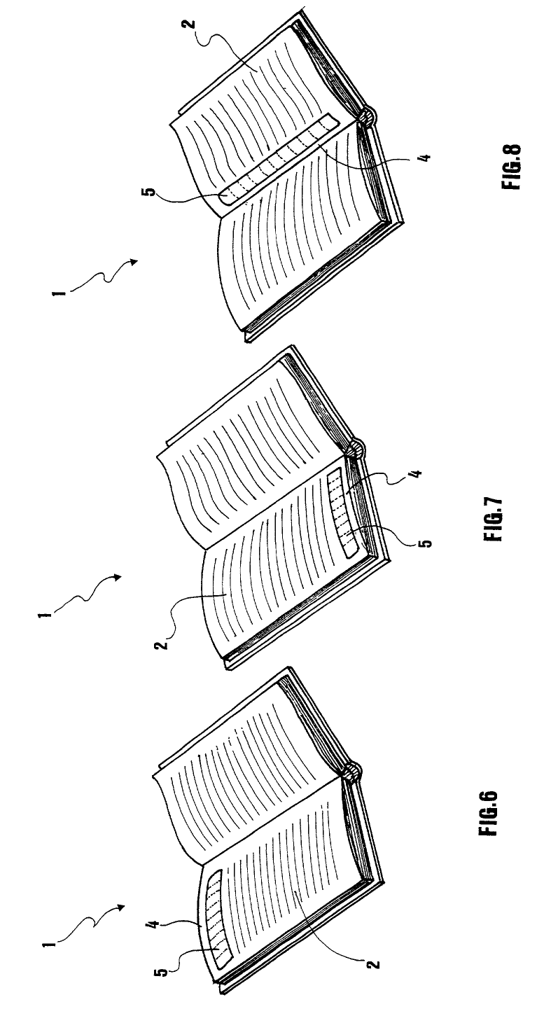

FIGS. 6, 7 and 8 show some positioning variants of the device according to the invention in a perspective view.

With reference to the Figures, a book-structured support is indicated with 1 and has a plurality of pages 2. To a page 2, in particular to a surface 3 thereof at a side edge 4, a device 5 to emit a scent is associated.

Such device comprises a cover panel 6, of elongated shape, in particular a paper web section, arranged parallelly to said edge 4. The panel 6 has a plurality of glue lines onto the inner face 7 thereof apt to contact said surface 3 of page 2.

In particular, the panel has a first glue line 8, of the removable and reversible adhesive type, at the edge of page 2 and arranged lengthwise to the cover panel 6, in order to be spaced from the respective edge of the cover panel 6 so as to define a band constituting a tear-off tab 9 elongated over the entire cover panel 6.

The panel 6 further has a second glue line 10 oppositely arranged with respect to the first glue line 8, i.e. at the other edge of the panel 6. The second glue line 10 is of the permanent and irreversible adhesive type, so as to constitute an elongated rotatable connection onto the entire cover panel 6.

The panel further has third glue lines 11 arranged at the ends thereof in order to connect said first and second glue line 8, 10. The third glue lines are of the removable and reversible adhesive type, like that of the first glue line 8. Overall, the glue lines 8, 10, 11 seal completely off the cover panel 6, which thus delimits a pocket 12 housing a pad member 13, of elongated shape and made of an absorbent material, bearing a scent to be emitted.

The pad member 13 is of laminar type, rectangular, and it is connected to the surface 3 of page 2 in the manner that will be detailed hereinafter.

Hence, the glue lines 8, 10, 11 form a gapless sealed contour of said pocket, maintaining the panel 6 adhered to the surface 3 of page 2.

The cover panel is crossed by a plurality of easy-tearing lines 14, evenly spaced and perpendicular to the development of the panel 6 and of the pad member 13, delimiting a corresponding plurality of removable areas 15 of the cover panel 6 at respective portions 16 of the pad member 13.

Therefore, the easy-tearing lines 14 are parallel among them and extend from one edge to another of the control panel 6, crossing the band constituting the tear-off tab 9.

Hence, each removable area 15 comprises its own tab and its own rotatable connection.

In the present embodiment, the easy-tearing lines 14 are arranged in close pairs, each pair defining a sealing strip 19 which divides respective removable areas 15.

At each of said strips 19, the device 5 comprises a fourth glue line 20 of said plurality of glue lines onto the face apt to contact the pad member 13. The fourth glue line 20, cooperating with the easy-tearing lines 14 to divide the respective removable areas 9, adheres to the surface 3 of the page 2 and also to the pad member 13, dividing the portions 16 of the pad member 14 among them (FIGS. 4, 5).

The fourth glue line 20 is of the permanent and irreversible adhesive type.

The device 5 further comprises sealing means of said pad member 13 inside said pocket 12.

Said sealing means comprises a first glue layer 17 which is uniformly laid between said pad member 13 and the surface 3 of the page 2, thereby preventing a direct contact of the latter with the pad member 13 and a scent transpiration.

Said first layer 17 is also apt to maintain the pad member 13 adhered to the surface 3 of the page 2 inside the pocket 12.

The sealing means further comprises a second glue layer 18 which is uniformly laid onto the inner face 7 of the cover panel 6 at an area which totally overlaps the pad 13, practically onto the entire inner face 7.

The second layer 18 prevents a direct contact between the pad member 13 and the cover panel 6, as well as a scent transpiration.

Therefore, the second glue layer 18 does not carry out the function of gluing the panel 6 to the pad member 13.

The use of the above described sealing means 17, 18 allows to employ paper-type materials and adhesives, the latter ones in particular for the panel 6 and the pad member 13, yielding an ecologically compatible device.

With reference to FIGS. 6, 7, 8, the device may be positioned on any edge of the page at issue, or, casewise, even at a central position thereof.

Different positionings may be alternated to avoid an excessive thickening of an individual edge of the book-structured support.

Obviously, several variants provide that devices as the above disclosed ones occupy a whole page or the centre thereof, or anyhow a page member associated to a book-shaped supporting structure.

Another variant provides that a plurality of devices is gathered on several pages of a book-shaped supporting structure, e.g., in the final pages, with an index and/or with captions for the guided employ of the individual devices.

Moreover, the shape of the pad member 13 and of the cover panel 6 is not limited to a rectangular strip: the possible shapes, colours and designs thereof are multifarious and may be reminiscent of the written text as well as of the type of scent saturating the pad member 13. For example, the cover panel 6 may have the shape and the design of a fruit like an apple, or of a flower, or any other design.

Also the shape of the removable areas 15 and of the respective portions 16 of the pad member 13 is not limited, and can take the shape, e.g., of stripes transversely crossing the cover panel 6.

As to the operation of the device 5, the reader, possibly informed by an indicator on the page 2, for instance a word printed in a colour recalling the scent of the object it represents, e.g., green—lawn, and which also characterises the visible surface of the cover panel 6, is induced to smell the scent associated to said object.

Obviously, further association systems in a written or designed form may be provided.

The reader may then lift a removable area 15 of panel 6 grasping it at the tab 9 and rotating it with respect to the second glue line 10.

By pulling, the removable area 15 divides from the remaining portion of the cover panel 6 by tearing-off the tearing lines 14 sideways to the area 15. The strips 19 adjacent to the removed area 15 remain adhered to the surface 3 of the page 2 and to the pad member 13, maintaining the remaining portions of the pad member 13 sealed, preventing air penetration and the release of the scent.

Thus, a portion 16 of the pad member 13 is exposed. The pad member may, e.g., be of the type releasing the scent upon friction, by contact, and in that case the reader, in order to better appreciate the scent, may touch the exposed portion and approach the scent to the nostrils.

Otherwise, the pad member may be of the type releasing the scent if dampened, and accordingly the reader may dampen the exposed portion 16 with its own saliva.

Otherwise, the pad member may release scent if it gets in contact with air, and therefore it will suffice to expose the pad member portion.

Anyhow, the exposed portion 16 may be covered up once more, by virtue of the reversibility of the glue of the first and third glue lines 8, 11.

In case of depletion of a portion 16 of the pad member 13, the former may be left covered or definitively exposed, tearing off the corresponding removable area 15 of the cover panel 6. However, a subsequent portion 16 is available.

Among the possible variants of the above disclosed embodiment, the one related to a device with a cover panel obtained folding an elongated edge of the page is relevant. Thus, the rotatable connection would consist of the creasing, in lieu of the second glue line, and the sense of rotation of each removable area would be inverted, one removable area thus being capable of constituting a projecting bookmark tongue.

Another variant may consist in the removability of the individual pad member portions, in case easy-tearing lines are prearranged at the sealing strips, and also in the removability of the entire device upon depletion of the pad member.

To these purposes, the pad member may be provided with a second sealing layer made of a reversible glue whose adherence to the pad is stronger than the adherence binding it to the page surface.

Thus, upon depletion of the pad member and complete removal of the cover panel, the entire device is removable, leaving no trace of adhesive on the page.

Besides the above mentioned advantages, the above described device is substantially made of two parts, panel and pad member, which may easily be assembled by automatic processing in the paper industry field, using suitable glue layer and line application devices.

Hence, the above described device is suitable in the book industry for the production of books in industrial, as well as in limited, editions.

To the above described device to emit a scent and to the book-structured support incorporating it, those skilled in the art, in order to satisfy further and contingent needs, may introduce several further modifications and variants, all however falling within the protective scope of the present invention, as defined by the appended claims.

1. A device to emit a scent, associated to a book page or the like, comprising:
a pad member, bearing a scent to be emitted, of laminar type connected to a surface of said page;
a cover panel, applied to said page, delimiting a pocket which entirely houses said pad member, said cover panel comprising a plurality of easy-tearing lines delimiting a plurality of removable areas, at respective portions of the pad member; e
sealing means said pad member inside said pocket.

2. The device according to claim 1, wherein said sealing means comprises a first glue layer uniformly laid between said pad member and the surface of the page, so as to prevent a direct contact between the pad member and the surface of the page and a scent transpiration, and apt to maintain the pad member adhered to the surface of the page.

3. The device according to claim 2, wherein the sealing means comprises a second glue layer uniformly laid onto a face of the cover panel, apt to contact said pad member, at an area which totally overlaps the pad member, thereby preventing a direct contact between the pad member and said face and a scent transpiration.

4. The device according to claim 1, wherein the pad member and the respective cover panel have an elongated shape, apt to be positioned near to an edge of the page.

5. The device according to claim 1, wherein the cover panel has a plurality of glue lines apt to define the contour of said pocket and to maintain the cover panel adhered to the surface of the page.

6. The device according to claim 5, wherein first glue lines of said plurality are arranged spaced from an edge of said cover panel, so as to define a band constituting a tear-off tab for each of said removable areas, said band being crossed by said easy-tearing lines.

7. The device according to claim 5, wherein second glue lines of said plurality are arranged oppositely to said first glue lines.

8. The device according to claims 4, wherein said first and said second glue lines are arranged lengthwise to the pad member and to the cover panel, the latter having transversal third glue lines at the ends thereof.

9. The device according to claim 8, wherein said first and third glue lines are of the removable reversible adhesive type, whereas said second glue lines are of the permanent irreversible adhesive type, apt to constitute a rotatable connection for each removable area.

10. The device according to claim 1, wherein the pad member is of the type releasing the scent thereof upon contact.

11. The device according to claim 1, wherein the pad member is of the type releasing the scent thereof if dampened.

12. The device according to claim 1, wherein the easy-tearing lines are arranged in close pairs, each pair defining a sealing strip dividing respective removable areas, at each of said strips the device comprising, on the face apt to contact the pad member, a glue line cooperating with the easy-tearing lines to divide respective removable areas, adhering to the surface of the page and also to the pad member, dividing the portions of the pad member among them, said glue line being of the permanent and irreversible adhesive type.

13. A book-structured support, comprising a plurality of pages, having one or more devices according to any one of the preceding claims, associated to a respective page.
